(19) United States
(12) Patent Application Publication
(10) Pub. No.: US 2006/0281445 A1
(43) Pub. Date: Dec. 14, 2006

(54) Method and system for automatic call forwarding for dual-mode handsets

(76) Inventor: Timothy A. Dickinson, Crystal Lake, IL (US)

Correspondence Address: MOTOROLA INC, 600 NORTH US HIGHWAY 45, ROOM AS437, LIBERTYVILLE, IL, 60048-5343, US

(21) Appl. No.: 11/152,483

(22) Filed: Jun. 14, 2005

(51) Int. Cl. H04M 3/42

(52) U.S. Cl. 455/417; 455/428

(57) ABSTRACT

Disclosed is a method and system of a communication device of a cellular network. The method is for initialization of the communication device to effect call forwarding communication from the cellular network to a landline base station having an identification. The method includes that the communication device generates a prompt for input of the base station identification, receives an input of the base station identification, and processes the identification to configure the communication device to generate a signal for call forwarding from the cellular network to the base station when the communication device detects a signal from the base station. Upon detecting the base station signal, the communication device generates an output signal for transmission to the cellular network to effect call forwarding from the cellular network to the base station and then communicates with the base station.

### FIELD OF THE INVENTION

This invention relates to call forwarding between a cellular network and a landline network.

### BACKGROUND OF THE INVENTION

Telephone systems including wireless and wired systems provide call forwarding to redirect incoming calls to another number. Historically, call forwarding service provides a user the ability to avoid giving others a list of telephone numbers at which he or she may be reached. For example, if a user is outside a service area, calls may be redirected to a then local number. Once the call forwarding is effected, the user's first telephone will not ring, but the forwarded number will ring.

Oftentimes, users will have access to both cellular and landline (also known as wireline) systems. However, the cost of a cellular call is typically higher than the cost of a landline call. Therefore, there is substantial economic incentive for wireless subscribers to use landline telephone communications as much as possible. Accordingly, different call forwarding strategies allow users to call forward their cellular calls to landlines.

### BRIEF DESCRIPTION OF THE DRAWINGS

FIG. 1 depicts an exemplary embodiment of a communication device in communication with a base station that is in turn in communication with a landline network;

FIG. 2 is an exemplary flow chart of a method for initialization of the communication device to effect call forward communication from the cellular network to one or more base stations having identifications;

FIG. 3 is an exemplary signal diagram showing detecting action of the communication device as the communication device moves from cellular coverage to the base station signal reach; and

FIG. 4 is an exemplary signal diagram showing non-detecting action of the communication device as the communication device moves away from base station signal reach.

### DETAILED DESCRIPTION OF THE INVENTION

Disclosed is a method operable by a communication device and a communication device, the method for initialization of the communication device to effect call forward communication from the cellular network to a base station that is operatively connected to a landline network (also known as a wireline network), the base station having a particular identification. In the communication device, by generating a prompt for input of the base station identification, and receiving an input of the base station identification, the communication device may process the base station identification to configure the communication device to generate a signal for call forwarding from the cellular network to the landline network of the base station.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

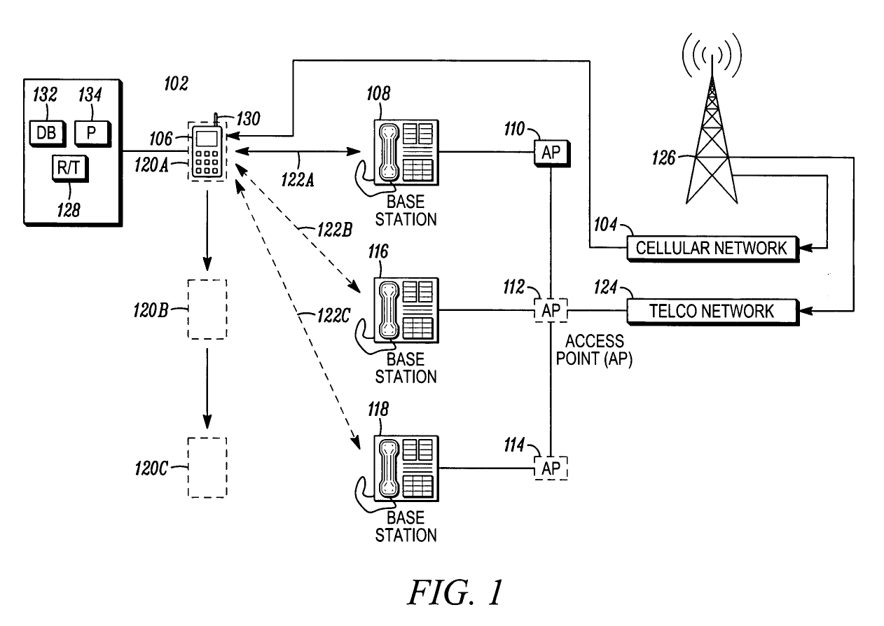

FIG. 1 depicts an exemplary embodiment of a communication device in communication with a base station that is in turn in communication with a landline network. The communication device 102 can be one of a wide variety of handheld wireless devices. Such handheld wireless devices or user equipment include, for example, cellular phones, pagers, radios, personal digital assistants (PDAs), notebook or laptop computers incorporating wireless modems, mobile data terminals, application specific gaming devices and video gaming devices incorporating wireless modems. An exemplary communication device 102 is depicted as a cellular telephone in communication with a cellular network 104.

The communication device provides a prompt to the user for a base station identification. The communication device 102 includes input capability 106 that can be tactile, audio, by a signal or by a combination for receiving data in call forwarding set up mode discussed below. In a first exemplary embodiment, the first base station 108 identification is input to the communication device. The input capability 106 receives the input and communication device 102 is configured so that the signals of the first base station 108 may be detected by the communication device. When the communication device 102 is configured to detect the signal of the base station 108, the communication device 102 can activate its call forwarding protocol, and effect call forwarding from the cellular network 104 to the base station 108.

The user of the communication device 102 may roam within signal reach of a base station 108 that in turn may be in communication with an access point 110 of the landline network. The base station 108 is a wireless device that may support one or more wireless or wired connections. The base station 108 may be at the user's office or the user's home. Often times, an office may be part of an office complex having a plurality of base stations. For example, the user may roam within the signal reach of a plurality of base stations 108, 116 and 118 that are supported by APs 110, 112 and 114.

The three base stations and the three AP devices are depicted to illustrate that one the user may roam from the area supported by base station 108 to the area supported by base station 116 and to the area supported by base station 118. In general, a wireless access point (WAP or AP) is a device that “connects” wireless communication devices together to create a wireless network. A wireless access point acts as the network's arbitrator, negotiating when each nearby client device can transmit. The WAP is also usually connected to a wired network, and can relay data between devices on each side. Many access points can be connected together to create a larger network that allows “roaming” within the network infrastructure. The base station and AP device arrangement can be wide or small, and the method described herein encompasses the full range of networks. It is understood that a network where the client devices manage themselves (called an ad-hoc network) is also included in this discussion.

Since base stations communicate with APs and their respective wireless handsets, they transmit and receive signals. The APs need not be wireless as long as the base station is configured to transmit wireless signals. In FIG. 1, the communication device 102 is depicted in different positions 120a, 120b and 120c. Accordingly, the communication device can roam between positions that are in communication with one or more base stations 108, 116 and 118. In position 120a, the communication device 102 is in communication 122a with base station 108 and not necessarily in communication 122b or 122c with base stations 116 and 118 respectively. However, if the user with the communication device 102 roams to position 120b within wireless communication reach of base station 116, communication 122b may be activated, and communication 122a may be deactivated. Likewise, if the user with the communication device 102 roams to position 120c within wireless communication signal reach of base station 118, communication 122c may be activated and communication 122b may be deactivated.

Solid lines depict AP 110 in FIG. 1 since the AP may serve more than one base station. Alternatively, more than one access point, AP 112 and AP 114 may serve a plurality of base stations. In the exemplary embodiment of FIG. 1, the configuration of the base stations and the AP illustrates the roaming capability of the communication device 102. In any event, one or more APs is a part of a landline network here referred to as telco network 124 which in turn may receive communication from cellular tower 126 and/or telephone wires.

As mentioned above, the handset, communication device 102 includes input capability 106. The user configures an automatic call forwarding profile directly in the handset. The communication device 102, in call forwarding set up mode, can prompt the user for a base station ID, for example the media access control (MAC) address, the service set identifier (SSID) or other station identifier. Prompts for other information may be made at the same time or later for data such as the cellular telephone numbers to forward (since most cellular telephone support more than one telephone number) and a telephone number to which calls can be automatically forwarded. As illustrated by the roaming capability depicted in FIG. 1, the electronic device 102 can process several profiles, each with different station identifiers and forwarding numbers. In this way, for example, were the user to approach his/her place of work, the electronic device 102 can detect a signal of the wireless network there (WLAN or Bluetooth, BT) and automatically forward “work” calls to the user's desk. Another profile can be applied, for example, for interaction with the user's home telephone.

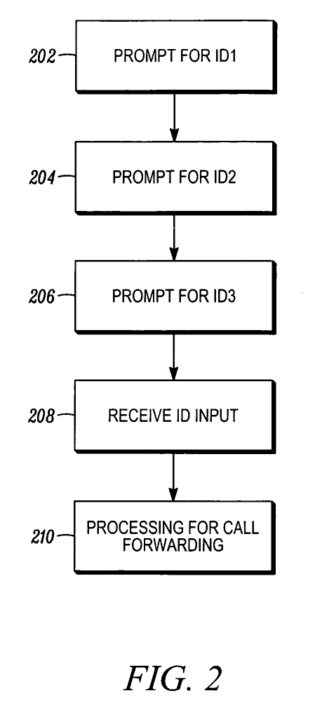

Now turning to FIG. 2, a flow chart is shown of a method for initialization of the communication device to effect call forward communication from the cellular network to one or more base stations having identifications. The communication device 102 will prompt 202, 204 and 206 for IDs 1-3, which, for example, may be correlated to base stations 108, 116 and 118 of FIG. 1. The ID input is received 208 and the processing for call forwarding is processed 210 by the communication device 102.

The APs 110, 112, and/or 114, that may contain public switched telephone network (PSTN) interfaces that allow for interaction with the PSTN line from a wireless mobile device, such as communication device 102. Inbound and outbound calls can be processed through AP 112, for example. The electronic device 102, which is a dual mode device, can be configured to process calls in WLAN and/or BT modes.

Once calls are forwarded to a new number (for example, the user's home telephone number) all inbound cellular calls will ring on the user's home line. Such calls can be answered using the user's normal landline telephone equipment. Additionally, these calls can still be answered on the user's communication device 102 since the handset is “attached” to the home AP, which has a PSTN interface. Likewise, while in WLAN/BT mode, all outbound calls made from the communication device 102 are routed through the AP and PSTN connection. In this way, the communication device 102 acts as a cordless landline telephone equipment.

The instructions for the call forwarding are processed by the communication device 102 and so the call forwarding is controllable via the mobile switching center (MSC). Call forwarding features can be enabled and disabled rapidly from the cellular portion of the communication device 102. Accordingly, the process can be triggered by the action of the communication device 102 of detecting a signal of the home base station 108, 116 or 118, for example by the transmitter/receiver 128 that operates via antenna 130. The communication device 102 further includes a data base 132 and a processor 134. The base station signal detection can occur while the communication device 102 is receiving and transmitting on the cellular network.

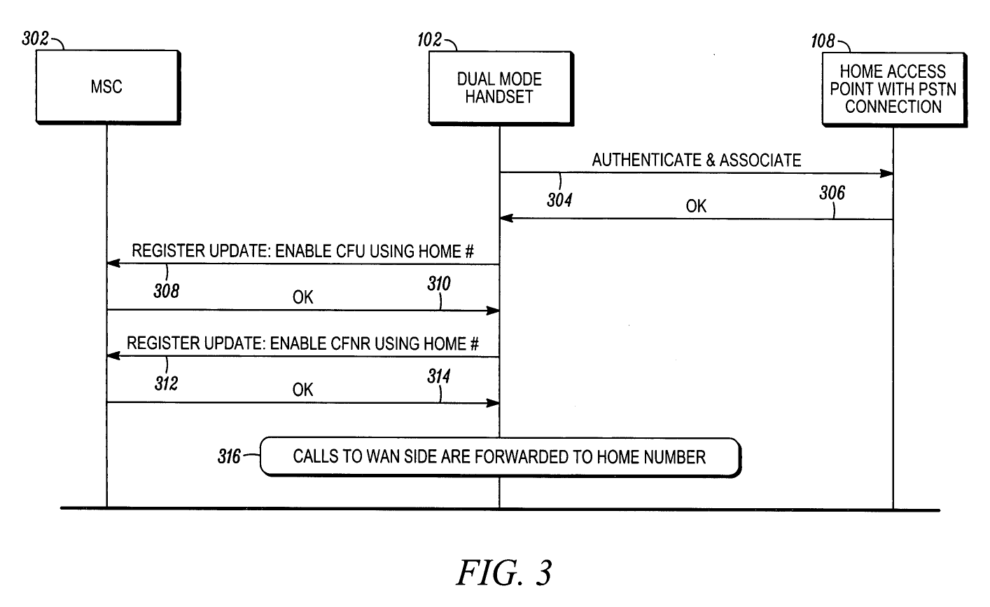

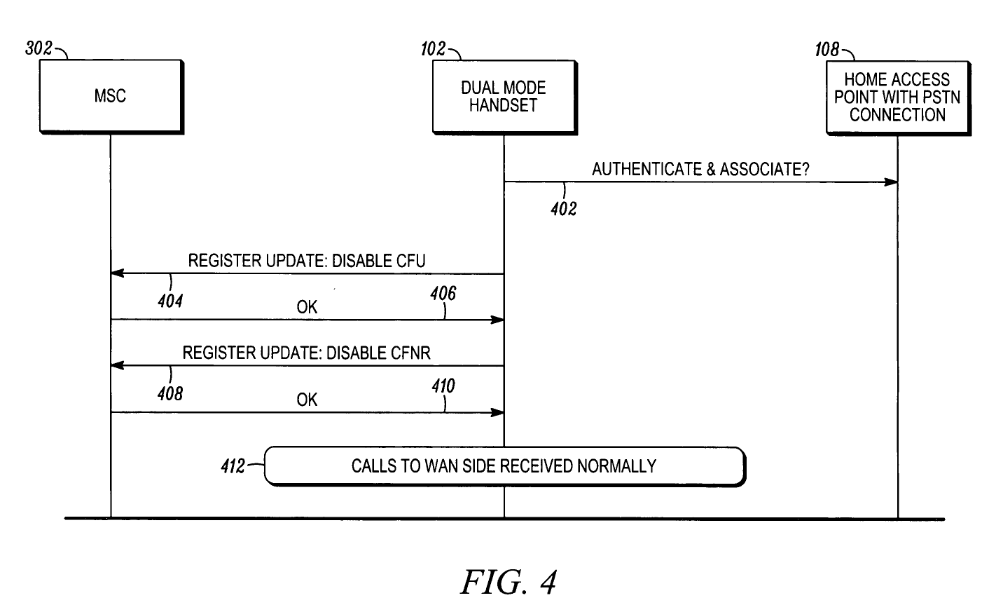

FIGS. 3 and 4 show an exemplary detecting process as communication device 102 moves from cellular or wide area network (WAN) coverage into the base station signal reach, and vice versa. As discussed in detail above, the communication device may move between and in and out of base station signal coverage areas. In FIG. 3, the MSC 302, the communication device 102, also referred to as the dual mode handset, and the base station 108 (or AP 110) with a PSTN connection are in communication.

The communication device 102 may be provisioned upon manufacture as a dual mode handset, that is, operable in the cellular environment and the PSTN environment. It may also be retrofitted after manufacture with the software to perform dual mode functions described herein. The software may be installed by connecting the handset to a physical port, or by downloading instructions from a wireless provider to perform the dual mode functions as described herein.

As illustrated in FIG. 2, upon displaying a prompt 202, 204 and/or 206 the identification of the base station 108 can be provided to the communication device 102. As discussed, more than one base station ID may be stored in the handset. The communication device detects via the receiver/transmitter 128 the base station signal and the absence of the base station signal. Briefly returning to FIG. 1, database 132 stores a plurality of base station identifications. The processor 134 receives instructions to process the base station signal data and generates a communication signal to the cellular network to forward calls to the base station.

More specifically, when the communication device detects the signal of a base station, the devices engage in authentication and association 304. Handshaking or other protocol may then activate communication 306 between the communication device 102 and the base station 108.

After signal initialization between the communication device and the base station, correspondence between the communication device and the mobile switching center (MSC) may take place. Signal initialization may be transparent to the user. The user only needs to roam within the signal reach of the base station 108.

The update information of enabling the call forwarding unconditional (CFU) can be registered by the communication device with the MSC 308. In this exemplary embodiment, a call forwarding unconditional setting at the MSC 308 will forward all calls and override all other call forwarding conditions. The CFU may be requested by the communication device. A handshake 310 acknowledges the CFU registration when requested by the communication device. A second correspondence between the communication device and the MSC 308 may take place. The update information of enabling the call forwarding not reachable (CFNR) request may be registered by the communication device with the MSC 312. The Call forwarding not reachable setting handles the case where calls are forwarded to a new number only after paging the cellular user and no response was received (e.g. the users phone was off or out of cellular coverage). A handshake 314 acknowledges the CFNR registration. Accordingly, the cellular calls of the communication device may then be forwarded 316 to the base station or home access point having the PSTN connection 108.

As illustrated in FIG. 1, the user may roam out of the signal reach of the base station 108. The user may roam into the signal reach of a different base station. If so, the signal communication and process described with reference to FIG. 3 would take place with reference to the new base station. The operation of FIG. 4 of disabling communication between communication device 102 and base station 108 would also take place. Furthermore, if the user roams outside the signal reach of any base station for which communication has been established, the operation of FIG. 4 would take place and the MSC 308 would not forward the calls to a described base station, but would then send the calls to the communication device. Other call forwarding arrangements may be made that do not include the described base stations.

Referring to FIG. 4 for disabling call forwarding, communication between the communication device 102 and the home AP with PSTN connection 108 may include further authentication and association 402. In this operation, the correspondence between the communication device 102 and the MSC 302 includes an update to disable CFU 404. A handshake 406 acknowledges the registration update 404. A second correspondence between the communication device and the MSC may take place. The update information of disabling the CFNR 408 can be registered by the communication device with the MSC 312. A handshake 410 acknowledges the CFNR 408 disable. Accordingly, the cellular calls of the communication device may be sent to the communication device itself 412 or may be call forwarded in another manner.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method in a communication device of a cellular network, the method for initialization of the communication device to effect call forward communication from the cellular network to a base station having an identification, the method comprising:
generating a prompt for input of the base station identification;
receiving an input of the base station identification; and
processing the identification to configure the communication device to generate a signal for call forwarding from the cellular network to the base station.

2. A method as recited in claim 1 wherein a second base station has a different identification, the method of the communication device further comprising:
generating another prompt for input of the second base station identification;
receiving an input of the second base station identification; and
processing the identification to configure the communication device to generate a signal for call forwarding from the cellular network to the second base station.

3. A method as recited in claim 1 wherein a third base station has a different identification, the method further comprising:
generating another prompt for input of the third base station identification;
receiving an input of the third base station identification; and
processing the identification to configure the communication device to generate a signal for call forwarding from the cellular network to the third base station.

4. A method as recited in claim 1 in the communication device further for establishing call forwarding from the cellular network to the base station having a signal, the method further comprising:
detecting the base station signal;
generating an output signal for transmission to the cellular network to effect call forwarding from the cellular network to the base station when the communication device detects the base station signal; and
communicating with the base station.

5. A method as recited in claim 4 in communication device further for establishing communication with the cellular network, the method further comprising:
detecting an absence of the base station signal;
generating an output signal for transmission to the cellular network to establish communication with the cellular network when the communication device detects the absence of the base station signal; and
communicating with the cellular network.

6. A method as recited in claim 1 wherein the communication device is a cellular telephone.

7. A method as recited in claim 1 wherein the base station has access to a wireline.

8. A method in a communication device in communication with a cellular network, the method for call forwarding from the cellular network to a base station having a signal, the method comprising:
detecting the base station signal;
generating an output signal for transmission to the cellular network to effect call forwarding from the cellular network to the base station; and
communicating with the base station.

9. A method as recited in claim 8 in communication device for establishing communication with the cellular network, the method further comprising:
detecting an absence of the base station signal;
generating an output signal for transmission to the cellular network to establish communication with the cellular network when the communication device detects the absence of the base station signal; and
communicating with the cellular network.

10. A method as recited in claim 8 wherein the base station is authenticated by the communication device, the authentication comprising:
generating a prompt for input of the base station identification;
receiving an input of the base station identification; and
processing the identification to configure the communication device to generate a signal for call forwarding from the cellular network to the base station.

11. A method as recited in claim 8 wherein antecedent to detecting the base station signal, a plurality of base stations are authenticated by the communication device, the authentication comprising:
generating a prompt for input of the plurality of base station identifications;
receiving input of the base station identifications; and
processing the identifications to configure the communication device to generate signals for call forwarding from the cellular network to at least one of the plurality of base stations.

12. A method as recited in claim 8 wherein the communication device is a cellular telephone.

13. A method as recited in claim 8 wherein the base station has access to a wireline.

14. A communication device capable of communication with a cellular network and capable of communication with a base station having an identification, comprising:
a prompt module for generating a prompt of the communication device for input of the base station identification;
a receiving module for receiving an input of the base station identification; and
a processor for processing the identification to configure the communication device to generate a signal for call forwarding from the cellular network to the base station.

15. A communication device as recited in claim 14 wherein the prompt module is capable of generating a prompt for input of a plurality of base station identifications.

16. A communication device as recited in claim 14 wherein the receiving module is capable of receiving input of a plurality of base station identifications.

17. A communication device as recited in claim 16 wherein the processor is capable of processing the plurality of identifications to configure the communication device to generate a signal for call forwarding from the cellular network to one of the plurality of base stations.

18. A communication device as recited in claim 14 wherein the base station further has a base station signal, further comprising:
a detection module for detecting the base station signal;
an output signal module for generating an output signal for transmission to the cellular network to effect call forwarding from the cellular network to the base station; and
a communication module for communicating with the base station.

19. A communication device as recited in claim 14 wherein the base station further has a base station signal, further comprising:
a detection module for detecting an absence of the base station signal;
an output signal module for generating an output signal for transmission to the cellular network to establish communication with the cellular network when the communication device detects the absence of the base station signal; and
a communication module for communicating with the cellular network.

20. A communication device as recited in claim 14 wherein the communication device is a cellular telephone and the base station has access to a wireline.
